(19) United States
(12) Patent Application Publication
(10) Pub. No.: US 2007/0289095 A1
(43) Pub. Date: Dec. 20, 2007

(54) Hinge assembly

(76) Inventors: Charles E. Wagner, Winfield, KS (US); Kenny W. O'Grady, Winfiled, KS (US)

Correspondence Address: BOYLE FREDRICKSON S.C., 840 North Plankinton Avenue, MILWAUKEE, WI, 53203, US

(21) Appl. No.: 11/437,568

(22) Filed: May 19, 2006

(51) Int. Cl. E05D 7/10

(52) U.S. Cl. 16/267

(57) ABSTRACT

A hinge assembly for use in attaching, for example, a lid or a door is disclosed. The hinge assembly is economical to make and can stand up to a great deal of abuse. It easily assembled by an end user without the need for hand tools or traditional metal fasteners. The design of the hinge permits rotation of up to 270°. A method of using the hinge assembly to quickly and easily make a hinged connection with a door or lid of, for example, a storage system incorporating the hinge assembly is also disclosed.

### BACKGROUND OF THE INVENTION

1. Field of the Invention

The present invention relates to plastic hinges. More specifically, the present invention is directed to a blow-molded plastic hinge assembly incorporated within a storage system that is economical to produce, easy to install and holds up against repeated use.

2. Description of the Related Arts

Items such as cabinets, sheds, coolers can be made out of plastic in a very cost-effective as well as durable manner. The use of plastic, and especially integral, hinges on these items further reduces their cost of production. Plastic articles, including hinges, can be formed in a number of methods including injection-molding, blow-molding and compression-molding. Examples of plastic hinges and pivot pins constructed by various manners of molding can be seen in U.S. Pat. No. RE. 31,086 to Johnson, Jr. et al., U.S. Pat. No. 5,269,046 to Newby, Sr., U.S. Pat. No. 6,325,962 to Kmiecik et al., and U.S. Pat. App. Pub. No. 2005/0103797 to Rader et al.

U.S. Pat. No. 6,325,962 discloses an integral blow-molded hinge assembly and a method of manufacturing it. This hinge assembly includes a first member with a generally solid plastic T-shaped tongue portion with barrel protrusions and a second member with an integrally formed recessed portion. The recessed portion has slots to receive the barrel protrusions and when the two members are placed together, a hinged connection is formed. One drawback to this design is that the hinged connection can only travel a maximum of 180° of rotation. Another drawback is that the hinged connection is not locked in place in a disclosed “first position”. In this position, the two members only have a minimal frictional force holding them together and could easily become disengaged.

The plastic hinge disclosed in U.S. Pat. No. 5,269,046 also has this engagement problem, i.e., a position where a second member, such as a door or lid, is not fully engaged with a first member and may be inadvertently removed.

Another problem with other plastic hinges is that some hinge pieces must be flexed or forced into position. This problem exists with the plastic hinge disclosed in U.S. Pat. No. RE. 31,086. With this hinge, the receptacles must be flexed somewhat in order to accommodate the pivot pins. This flexing may weaken and even break the pivot pins or receptacles. Because the hinged pieces are formed integrally with the members to be joined, if a pivot pin or receptacle breaks, an entirely new member with an integral hinge piece would be needed.

Another problem with existing plastic hinges located on plastic products is that they have a history of failing prematurely. This is typically caused by hinge designs that attempt to limit travel of a lid or door using a positive stop near the hinge axis.

As a result of the drawbacks in the prior art, it is desirable to develop a plastic hinge assembly that can be molded, installed and removed easily without the use of tools, and be able to fully lock together the two members to be joined.

### SUMMARY OF THE INVENTION

The present invention is directed to a hinge assembly, a method of using the hinge assembly and a storage system incorporating the hinge assembly. The preferred hinge assembly has components that are durable, relatively simple and inexpensive to manufacture, can be easily assembled without tools and do not have any traditional metal fasteners.

One aspect of the present invention is a hinge assembly with components preferably made out of molded plastic that hingedly connect a first and second member. A preferred hinge block component has a barrel formed by opposite-facing cavities on a first end and a fastener located on a second end. The fastener is preferably comprised of a threaded rod and nut. The hinge block is fastened to the first member by inserting the threaded rod into a receptacle formed within the first member and screwing the nut onto the rod. The receptacle is formed so that when the hinge block is partially seated in the receptacle it can be rotated up to a one-eighth turn in a counter-clockwise direction. Both the nut and the back of the receptacle have a plurality of detent protrusions that engage each other to prevent the nut from unscrewing.

An exemplary second component of the hinge system is made up of two pivot pins integrally formed within the second member. When the opposite-facing cavities that comprise the barrel receive and engage the pins, a hinged connection is formed. The hinged connection forms both a pivot axis and an axis of rotation. Because the hinged connection is located at a distance away from the first member, at least 270° of rotation by the second member can be achieved.

The components, with the exception of the nut, can preferably be made out of blow-molded plastic with no secondary finishing required. The nut is preferably made out of injection-molded plastic also with no secondary finishing required. This will keep the cost of production down while producing a strong and durable hinge. The hinge block component can be easily removed if it needs to be replaced or if the second member needs to be removed. As mentioned before, no metal parts are incorporated anywhere in the hinge assembly.

The hinge assembly can be incorporated within a door and an enclosure such as a shed or within a lid and a free standing storage box. Preferably, the shed would have fully-enclosed side panels connected to a top and bottom, e.g., a floor and a roof. The hinge assembly would be used to hingedly mount a door to or within a side panel. Alternatively, the hinge assembly would hingedly connect a lid onto a storage box having a base and sides formed in one integral piece.

Another aspect of the present invention is a method of hingedly connecting two panels of a storage system such as a door and a wall or a lid and a box. The method comprises the following steps. First, insert a threaded rod of a hinge into a receptacle disposed in a first panel. Next, rotate the hinge in a first direction. Next, secure the hinge to the first panel once it has been rotated by placing and hand-tightening a nut on the threaded rod. Next, engage two pivot pins located on a second panel within opposite-facing cavities of a barrel of the hinge. Next, rotate the hinge in a second direction until the pivot pins are fully seated within the cavities. Finally, completely secure the hinge assembly by fully seating the hinge within the receptacle and tightening the nut.

A preferred method includes the receptacle limiting rotation of the hinge to a one-eighth turn. A further preferred method includes rotating the hinge in a counter-clockwise direction as the “first direction” stated above.

Another aspect of the present invention is a storage system comprising the following components a hinge system having two components, wherein a first component has a protruding threaded rod, a locking fastening nut, and a pivot pin receiving cavity, and a second component has at least one pivot pin; an enclosure connected to the hinge; and a panel connected to the hinge

One storage system incorporating the present invention includes a shed as the enclosure listed above and a door as the panel listed above. A second storage system incorporates an open box-shaped enclosure with a lid as the panel.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views.

In the drawings:

FIG. 1 is a partial perspective view of a hinge assembly in a preferred embodiment.

FIG. 2 is a perspective of a hinge block component of the hinge assembly of FIG. 1.

FIG. 3 is a partial perspective view of pivot pins of the hinge assembly of FIG. 1.

FIG. 4 is a front partial perspective view of a receptacle for a hinge block component.

FIG. 5 is a rear partial perspective view of the receptacle for a hinge block component.

FIG. 6 is a perspective view of the nut used to attach a hinge block component to a first member.

FIG. 7 is a partial perspective view of a mounted hinge block component.

FIG. 8 is a perspective view showing the first steps in assembling the hinge assembly of FIG. 1 which include affixing the hinge block component to a panel, rotating the hinge block component one-eighth of a turn, and fastening the hinge block component to the panel.

FIG. 9 is a perspective view showing the next steps in assembling the hinge assembly of FIG. 1 which includes engaging pivot pins of a door or lid within cavities of a barrel of the hinge block component.

FIG. 10 is a perspective view showing the final steps in assembling the hinge assembly of FIG. 1 which includes rotating the hinge block component in an opposite direction until the pivots pins are fully engaged within the barrel and completely securing the hinge block component to the panel.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “connected” or terms similar thereto, e.g., attached, are often used. They are not limited to direct connection but include connection through other elements where such connection is recognized as being equivalent by those skilled in the art.

### DETAILED DESCRIPTION OF THE INVENTION

The present invention and the various features and advantageous details thereof are explained more fully with reference to the non-limiting embodiments described in detail in the following description.

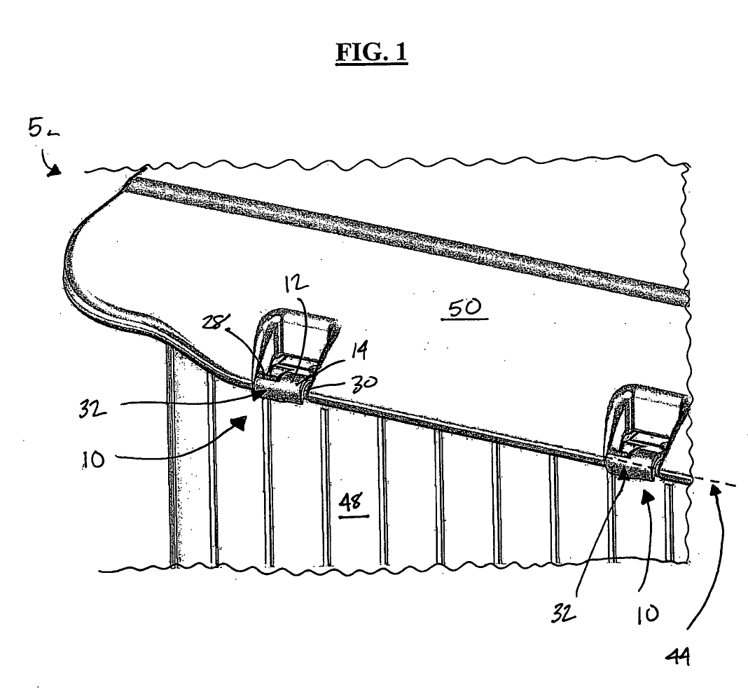

FIG. 1 shows a hinge assembly 10 of the present invention in a molded plastic box-type storage system application such as a cooler 52. The hinge assembly 10 is preferably made up of a first component or hinge block component 12 that is fastened to a wall or panel 48 and two pivot pins 28, 30 that are integrally formed within a lid or door 50. The pivot pins 28, 30 are received into a barrel 14 of the hinge block component 12 to form a hinged connection 32. The hinged connections 32 of at least two hinge assemblies 10 form a pivot axis 44, or axis of rotation, for the lid or door 50.

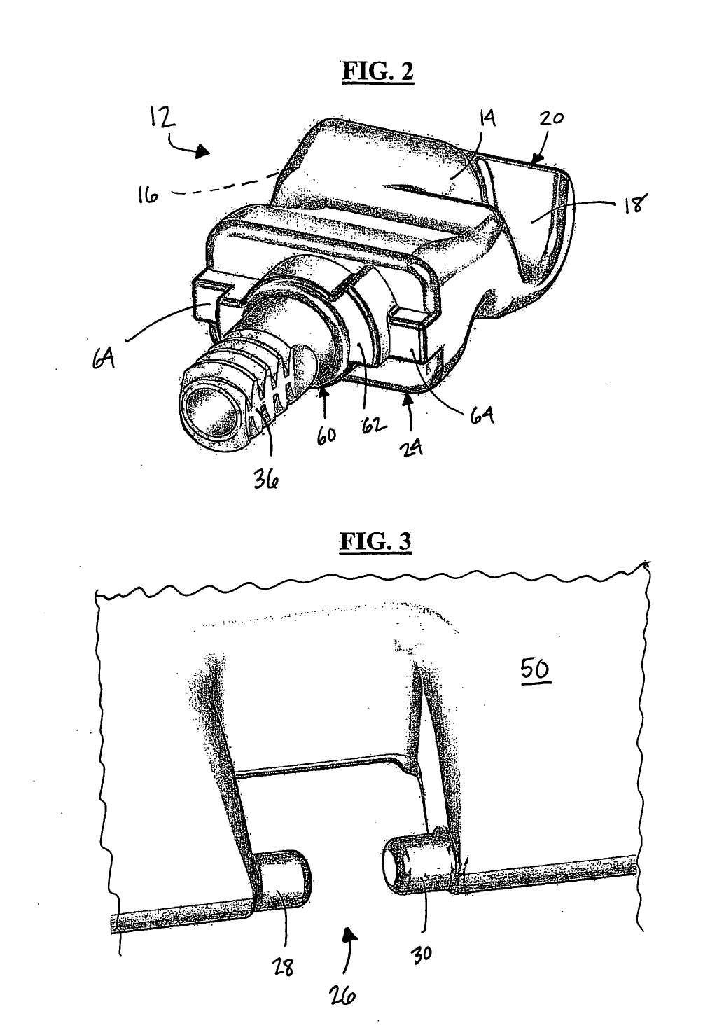

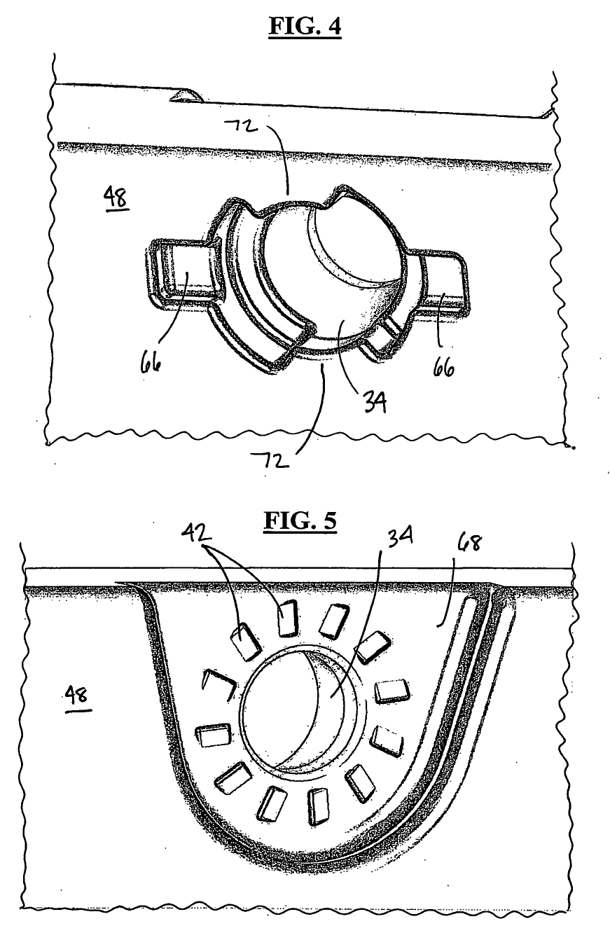

FIGS. 2-6 show the various aspects and components of one preferred hinge assembly 10. FIG. 2 shows the hinge block component 12. The hinge block component 12 has a barrel 14 formed by opposite facing cavities 16, 18 at a first end 20 and a threaded rod 36 at a second end 24. The threaded rod 36 acts as a fastener 22 when a plastic nut 38 is screwed onto the threaded rod 36. Also located at the second end 24 is a mating protrusion 60 that couples with a receptacle 34 (FIG. 4) located on the wall or panel 48. The mating protrusion 60 is comprised of two parts, a pivoting protrusion portion 62 and a locking protrusion portion 64. The pivoting protrusion portion 62 is designed so that when the hinge block component 12 is partially inserted into the receptacle 34, the hinge block component 12 can be rotated in a counter-clockwise direction up to one-eighth of a turn. At this point, the hinge block component 12 is stopped from further rotation by the pivoting protrusion portion 62 hitting a pair of stops 72 located within the receptacle 34. Once the hinge block component 12 is fully inserted into the receptacle 34, the locking protrusions 64 are received into corresponding square-shaped recesses 66 (FIG. 4) that make up part of the receptacle 34 and prevent the hinge block component 12 from rotating.

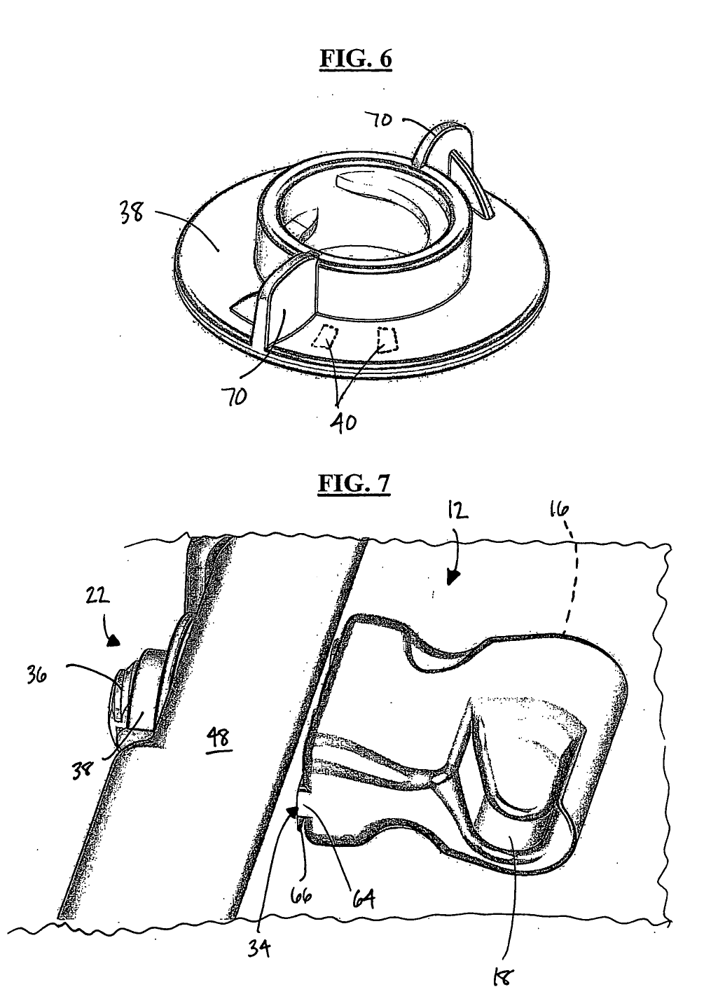

FIG. 3 shows the second member 26 with the two integral pivot pins 28, 30. FIG. 5 shows the detent protrusions 42 located on the rear side of the receptacle 34. The rear side of the receptacle 34 also has a recessed nut pocket 68 that helps prevent the nut 38 from unscrewing by shielding the nut 38 from being bumped or hit by objects. FIG. 6 shows the nut 38 with detent protrusions 40 that frictionally engage the detent protrusions 42 of the rear side of the receptacle 34 to further help prevent the nut 38 from unscrewing. Integral finger grips 70 aid in tightening the nut 38 without the need for tools.

FIG. 7 shows the hinge block component 12 attached to a panel 48 and held in place by the fastener 22. The hinge block component 12 is fully seated in the receptacle 34. Mating protrusions 64 are fully received within the square shaped recesses 66 of the receptacle 34. The nut 38 is fully hand-tightened on the threaded rod 36.

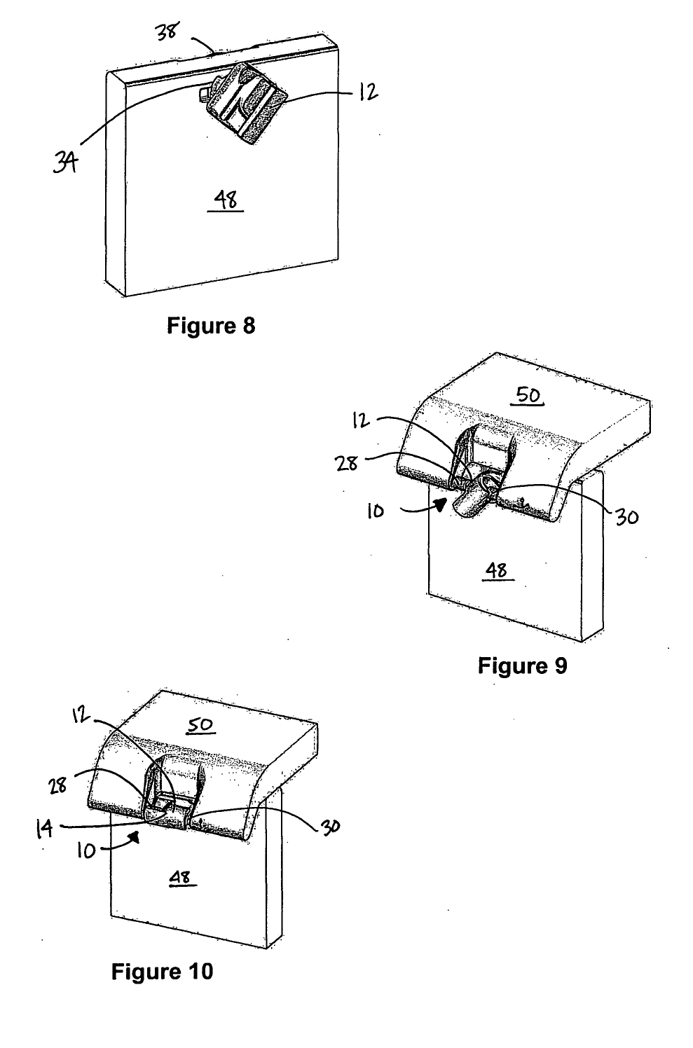

FIGS. 8-10 illustrate a preferred method of attaching a lid or door 50 to an enclosure such as a box or cooler 52 with the inventive hinge assembly 10. In FIG. 8, the hinge block component 12 is affixed to a first panel 48 by inserting the threaded rod 36 (not shown) into a receptacle 34. The hinge block component 12 is rotated counter-clockwise one-eighth of a turn and the nut 38 is screwed onto the threaded rod 36. In an actual application, preferably there are at least two hinge block components 12 that are installed approximately at the same time. Next, the door or lid 50 is placed onto the hinge as shown in FIG. 9. The angle of the hinge block component 12 allows the pivot pins 28, 30 to engage with the hinge block component 12. FIG. 10 shows the hinge block component 12 rotated a one-eighth turn clockwise and fully seated within the receptacle 34. At this point the pivot pins 28, 30 are essentially “captured,” or locked in place, within the barrel 14 of the hinge block component 12 and the hinged connection 32 is created. The nut 38 (not shown) is then fully tightened on the threaded rod 36 to secure the hinge block component 12.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept. For example, while the threaded rod 36 is disclosed herein to be part of the hinge assembly, it is possible that the so described threaded rod 36 may be used in other embodiments to act as a fastener 22 when a plastic nut 38 is screwed onto it.

Moreover, the individual components need not be fabricated from the disclosed materials, but could be fabricated from virtually any suitable materials. The individual components need not be formed in the disclosed shapes, or assembled in the disclosed configuration, but could be provided in virtually any shape, and assembled in virtually any configuration.

It is intended that the appended claims cover all such additions, modifications and rearrangements. Expedient embodiments of the present invention are differentiated by the appended claims.

What is claimed is:

1. A hinge assembly comprising:
(a) a hinge block component having a barrel formed by opposite-facing cavities at a first end and a fastener at a second end; and
(b) a second component having two opposed pivot pins;
wherein the hinge block component receives the second component to form a hinged connection.

2. The hinge assembly of claim 1, further comprising a receptacle to receive the fastener.

3. The hinge assembly of claim 2, wherein the fastener comprises a threaded rod and nut.

4. The hinge assembly of claim 3, wherein the nut has a plurality of detent protrusions.

5. The hinge assembly of claim 4, wherein the receptacle has a plurality of detent protrusions that act to lock the nut in place when engaged with the detent protrusions on the nut.

6. The hinge assembly of claim 2, wherein the receptacle permits the hinge block component to rotate up to a one-eighth turn when the hinge block component is not fully seated in the receptacle.

7. The hinge assembly of claim 6, wherein the receptacle permits the hinge block component to rotate in a counter-clockwise direction.

8. The hinge assembly of claim 1, wherein a pivot axis formed by the hinged connection is located a sufficient distance from the second end of the hinge block so as to permit at least 270° of rotation.

9. The hinge assembly of claim 1, wherein the components are constructed of molded plastic.

10. The hinge assembly of claim 9, wherein the components are formed by blow-molding.

11. The hinge assembly of claim 3, wherein the nut is formed by injection molding.

12. The hinge assembly of claim 1, wherein the pivot pins are integrally connected to the second component.

13. The hinge assembly of claim 1, wherein the hinge assembly connects panels connected to at least one of a: a top, a roof, a bottom, and a floor.

14. A method of connecting two panels with a hinge assembly, the method comprising the steps of:
(a) inserting a threaded rod of a hinge into a receptacle disposed in a first panel;
(b) rotating the hinge in a first direction;
(c) securing the hinge to the first panel by placing a nut on the threaded rod and hand-tightening the nut;
(d) engaging pivot pins of a second panel within opposite-facing cavities of a barrel of the hinge;
(e) rotating the hinge in a second direction until the pivot pins are fully seated within the cavities; and
(f) tightening the nut further until the hinge is fully seated and secured within the receptacle.

15. The method of claim 14, wherein the receptacle permits rotation of the hinge in a counter-clockwise direction.

16. The method of claim 14, wherein the receptacle limits rotation of the hinge to a one-eighth turn.

17. A storage system comprising:
a hinge system having two components, wherein a first component has a protruding threaded rod, a locking fastening nut, and a pivot pin receiving cavity, and a second component has at least one pivot pin;
an enclosure connected to the hinge; and
a panel connected to the hinge

18. The storage system of claim 17, wherein the panel is a door.

19. The storage system of claim 18, wherein the enclosure is a shed.

20. The storage system of claim 17, wherein the panel is a lid and the enclosure is a box.
